(19) United States
(12) Patent Application Publication
(10) Pub. No.: US 2018/0234580 A1
(43) Pub. Date: Aug. 16, 2018

(54) IMAGE PROCESSING FOR SELECTION OF AN ARRANGEMENT ORDER BASED ON FEATURE INFORMATION

(71) Applicants: KABUSHIKI KAISHA TOSHIBA, Tokyo (JP); TOSHIBA TEC KABUSHIKI KAISHA, Tokyo (JP)

(72) Inventor: Sunao Tabata, Sunto Shizuoka (JP)

(21) Appl. No.: 15/429,430

(22) Filed: Feb. 10, 2017

(51) Int. Cl. H04N 1/32; H04N 1/00

(52) U.S. Cl. CPC H04N 1/32464; H04N 1/00803; H04N 2201/0082; H04N 2201/0081; H04N 1/00811

(57) ABSTRACT

In accordance with an embodiment, an image processing apparatus comprises a scanner, an image data memory, a feature information acquisition section, an arrangement order determination section and an arrangement order change section. The scanner reads a plurality of sheets. The image data memory stores image data of each sheet read by the scanner. The feature information acquisition section acquires feature information indicating a feature of each of the sheets on the basis of the image data. The arrangement order determination section determines an arrangement order of the sheets on the basis of the feature information and order information indicating an arrangement of the sheets. The arrangement order change section rearranges the image data stored in the image data memory on the basis of the arrangement order determined by the arrangement order determination section.

### FIELD

Embodiments described herein relate generally to an image processing apparatus and an image processing method.

### BACKGROUND

Conventionally, there is a case in which an apparatus that carries out a scanning processing carries out a rearranging processing on the basis of information described on the front and back or page numbers in order to scan a large number of documents in order to align and digitize the documents.

However, in the conventional technology, there is a case in which it is difficult to carry out the rearranging processing of a sheet to which no page number is attached or a sheet of which the back surface is not blank.

### DESCRIPTION OF THE DRAWINGS

FIG. 1 is a diagram illustrating an example of the constitution of an image processing apparatus 1 according to a first embodiment;

FIG. 2 is a functional block diagram illustrating an example of functional components of the image processing apparatus 1 according to the first embodiment;

FIG. 3 is a diagram illustrating an example of display of an operation section 200 that receives order information AR;

FIG. 4 is a diagram illustrating a first example of a sheet ST read by a scanner 100;

FIG. 5 is a diagram illustrating a first example of image data G rearranged by an arrangement order change section 430;

FIG. 6 is a flowchart illustrating an example of operations of the image processing apparatus 1 according to the first embodiment;

FIG. 7 is a flowchart illustrating an example of determination of an arrangement order determination section 420 according to the first embodiment;

FIG. 8 is a diagram illustrating a second example of the sheet ST read by the scanner 100;

FIG. 9 is a diagram illustrating a second example of the image data G rearranged by the arrangement order change section 430;

FIG. 10 is a diagram illustrating a third example of the sheet ST read by the scanner 100;

FIG. 11 is a diagram illustrating a third example of the image data G rearranged by the arrangement order change section 430;

FIG. 12 is a functional block diagram illustrating an example of functional components of an image processing apparatus 2 according to a second embodiment;

FIG. 13 is a table illustrating an example of a priority PR according to the second embodiment;

FIG. 14 is a flowchart illustrating an example of determination of the arrangement order determination section 420 according to the second embodiment;

FIG. 15 is a functional block diagram illustrating an example of functional components of an image processing apparatus 3 according to a third embodiment; and

FIG. 16 is a flowchart illustrating an example of determination of the arrangement order determination section 420 according to a modification.

### DETAILED DESCRIPTION

In accordance with an embodiment, an image processing apparatus comprises a scanner, an image data memory, a feature information acquisition section, an arrangement order determination section and an arrangement order change section. The scanner reads a plurality of sheets. The image data memory stores image data of each sheet read by the scanner. The feature information acquisition section acquires feature information indicating a feature of each of the sheets on the basis of the image data. The arrangement order determination section determines an arrangement order of the sheets on the basis of the feature information and order information indicating an arrangement of the sheets. The arrangement order change section rearranges the image data stored in the image data memory on the basis of the arrangement order determined by the arrangement order determination section.

Hereinafter, a first embodiment of the present invention is described with reference to the accompanying drawings.

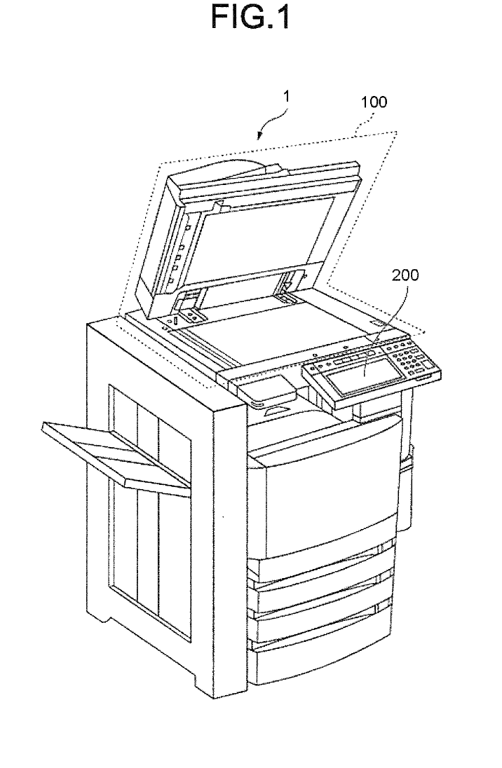

FIG. 1 is a diagram illustrating an example of the constitution of an image processing apparatus 1 according to the first embodiment.

The image processing apparatus 1 is, for example, an MFP (Multifunction Peripherals). The image processing apparatus 1 reads an image displayed on a sheet and generates digital data to generate image data G. The sheet is, for example, a document or a paper on which characters, images and the like are described. The sheet may be any object as long as it can be read by the image processing apparatus 1. In the illustrated example, the image processing apparatus 1 is provided with a scanner 100 and an operation section 200. Furthermore, the image processing apparatus 1 may be equipped with a printer section. In this case, the printer section of the image processing apparatus 1 may be a device for fixing a toner image or an inkjet type device.

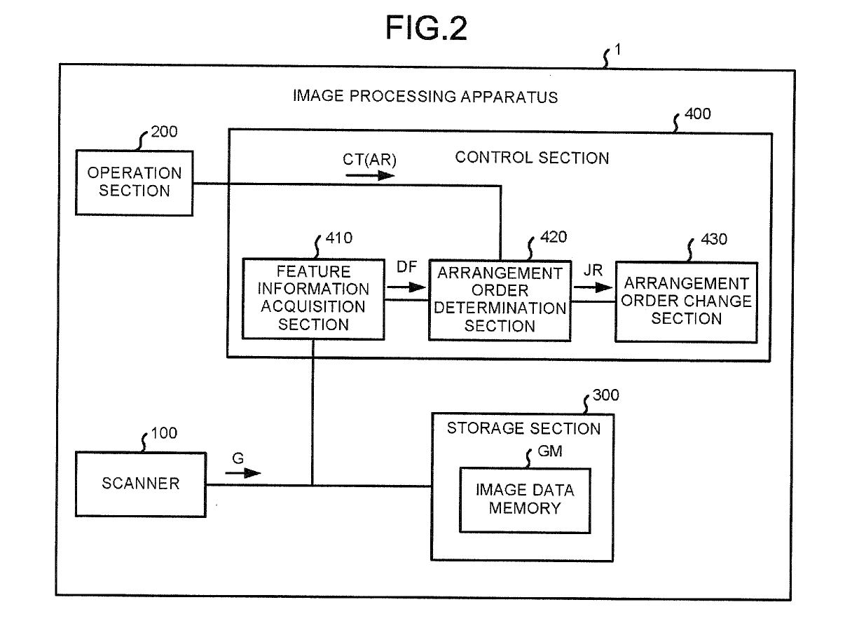

FIG. 2 is a functional block diagram illustrating an example of functional components of the image processing apparatus 1 according to the first embodiment.

The image processing apparatus 1 is provided with the scanner 100, the operation section 200, a storage section 300 and a control section 400.

The scanner 100 reads an image on a sheet ST with an image sensor such as a CCD and a CIS to generate image data G. The CCD is an abbreviation of Charge Coupled Device. The CIS is an abbreviation of Contact Image Sensor. The scanner 100 supplies the generated image data G to the storage section 300 and the control section 400.

The operation section 200 receives an input of an operation of a user to the image processing apparatus 1. Specifically, the operation section 200 is composed of a display device and an input device. The display device is, for example, a liquid crystal display and an organic EL (Electroluminescence) display. The input device is, for example, a keyboard and a touch panel. The operation section 200 supplies information input from the input device to the control section 400. The input information includes information relating to a processing carried out by the image processing apparatus 1. For example, the input information includes information indicating a processing category such as execution of scanning or execution of copying. For example, the input information includes setting information indicating duplex scan or simplex scan, resolution of scan, orientation of a scanned image and the like. Information relating to a processing to be carried out by the image processing apparatus 1 by the input of the user is referred to as instruction information CT. The operation section 200 is an example of a first input section.

The storage section 300 is provided with an image data memory GM. The image data memory GM stores the image data G generated by the scanner 100.

The control section 400 including a CPU (Central Processing Unit) or other processor is provided with a feature information acquisition section 410, an arrangement order determination section 420 and an arrangement order change section 430 as functional sections thereof.

The feature information acquisition section 410 acquires feature information DF on the basis of the image data G generated by the scanner 100. The feature information DF refers to information indicating a feature of each sheet ST.

The feature information DF is, for example, information indicating whether or not the sheet ST is a blank paper. Specifically, the feature information acquisition section 410 detects whether or not there are some descriptions on the sheet ST on the basis of the image data G acquired from the scanner 100. The feature information acquisition section 410 acquires information indicating that the sheet ST is the blank paper as the feature information DF in a case in which there are no descriptions on the sheet ST. In the following description, the feature information DF indicating that the sheet ST is the blank paper is referred to as feature information DF1. The feature information DF1 refers to an example of blank paper information.

In a case in which there are no descriptions on the sheet ST, the feature information acquisition section 410 may acquire information indicating that the sheet ST is not the blank paper as the feature information DF.

Further, the feature information DF is, for example, information indicating whether characters described on the sheet ST are Japanese or English. Specifically, the feature information acquisition section 410 detects whether the characters described on the sheet ST are Japanese or English on the basis of the image data G acquired from the scanner 100. The feature information acquisition section 410 acquires information indicating that the language described on the sheet ST is Japanese as the feature information DF in a case in which Japanese is described on the sheet ST. Alternatively, the feature information acquisition section 410 acquires information indicating that the language described on the sheet ST is English as the feature information DF in a case in which English is described on the sheet ST. In the following description, the feature information DF indicating that the language described on the sheet ST is Japanese or English is referred to as feature information DF2. The feature information DF2 refers to an example of language information.

In the foregoing description, a case in which the feature information acquisition section 410 detects whether the language described on the sheet ST is Japanese or English on the basis of the image data G is described; however, the present invention is not limited to this. The feature information acquisition section 410 may detect another language instead of Japanese or English. Furthermore, the feature information acquisition section 410 may detect at least one language of Japanese, English and another language.

Further, the feature information DF is, for example, information indicating a page number described on the sheet ST. Specifically, the feature information acquisition section 410 detects whether or not the page number is attached to positions of header and footer of the sheet ST on the basis of the image data G. The feature information acquisition section 410 acquires the page number as the feature information DF for each sheet ST in a case in which the page number is attached to the positions. In the following description, the feature information DF indicating the page number of the sheet ST is referred to as feature information DF3. The feature information DF3 refers to an example of page information.

The feature information acquisition section 410 may acquire information indicating that the page number is not attached to the positions of header and footer of the sheet ST as the feature information DF3 for each sheet ST.

Furthermore, the feature information acquisition section 410 may read out the image data G from the storage section 300 instead of acquiring the image data G from the scanner 100.

The feature information acquisition section 410 supplies the acquired feature information DF to the arrangement order determination section 420.

The arrangement order determination section 420 acquires the instruction information CT from the operation section 200. The instruction information CT includes order information AR. The order information AR refers to information indicating an arrangement of the sheets ST read by the scanner 100. In other words, the operation section 200 receives an input of the instruction information CT including the order information AR.

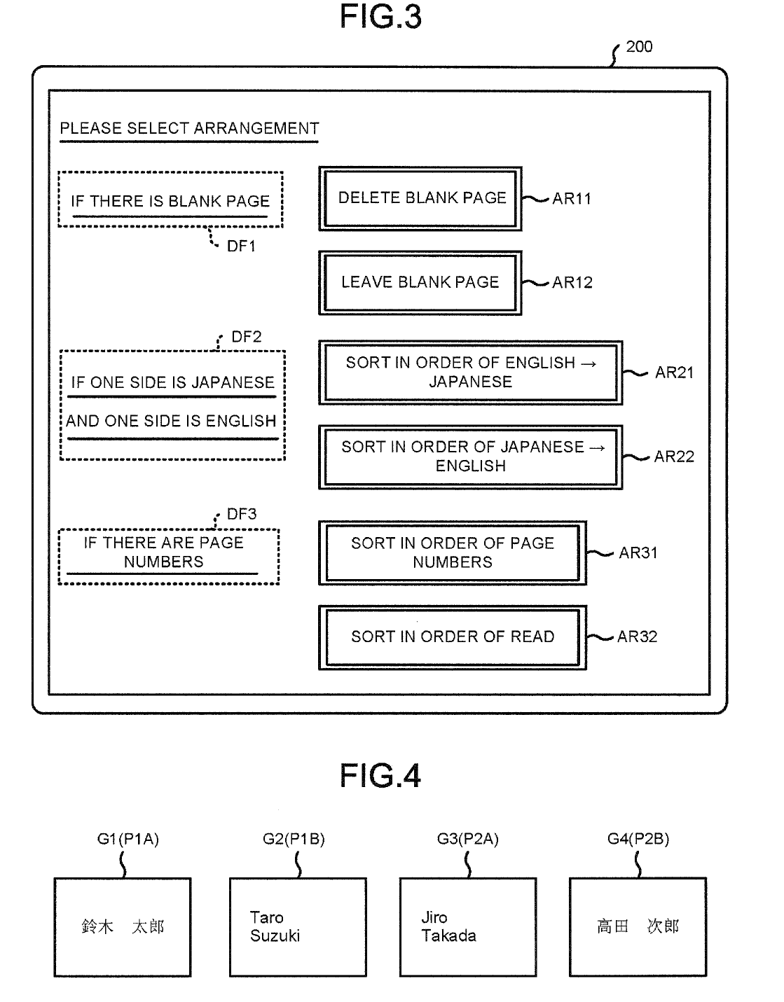

Hereinafter, the order information AR received by the operation section 200 is described with reference to FIG. 3.

FIG. 3 is a diagram illustrating an example of display of the operation section 200 that receives the order information AR.

The operation section 200 receives an input of the order information AR indicating the arrangement of the sheets ST which serves as information corresponding to the feature information DF acquired by the feature information acquisition section 410.

Specifically, the operation section 200 receives an input of order information AR11 or order information AR12 as the order information AR corresponding to the feature information DF1. The order information AR11 refers to information indicating an arrangement for deleting a blank page from the image data G in a case in which the blank page is included on the sheet ST. The order information AR12 refers to information indicating an arrangement for leaving a blank page from the image data G in a case in which the blank page is included on the sheet ST.

Further, the operation section 200 receives an input of the order information AR21 or the order information AR22 as the order information AR corresponding to the feature information DF2. The order information AR21 and the order information AR22 refer to information indicating an arrangement in a case in which a page described in Japanese and a page described in English are included alternately on the sheet ST. More specifically, the order information AR21 refers to information indicating an arrangement for arranging the page of Japanese after the page of English. The order information AR22 refers to information indicating an arrangement for arranging the page of English after the page of Japanese.

Further, the operation section 200 receives an input of order information AR31 or order information AR32 as the order information AR corresponding to the feature information DF3. The order information AR31 refers to information indicating an arrangement for arranging the sheets ST in the order of the page numbers in a case in which the page numbers are included on the sheets ST. The order information AR32 refers to information indicating an arrangement for arranging the sheets ST in the order of the read by the scanner 100 even in a case in which the page numbers are included on the sheets ST.

In one example of the present embodiment, the user instructs one order information AR in the plurality of the order information AR shown on the operation section 200. In other words, the operation section 200 receives the instruction information CT for instructing some order information AR in the plurality of the order information AR shown on the operation section 200, and supplies the received instruction information CT to the control section 400.

Returning to FIG. 2, the arrangement order determination section 420 acquires the instruction information CT including the order information AR from the operation section 200. Further, the arrangement order determination section 420 acquires the feature information DF of each sheet ST from the feature information acquisition section 410. The arrangement order determination section 420 determines the arrangement order of the sheets ST on the basis of the acquired feature information DF and order information AR. The arrangement order determination section 420 determines the arrangement order of the sheets ST, and supplies a determined result as a determination result JR to the arrangement order change section 430. Identification information indicating the order read by the scanner 100 is attached to the image data G of each sheet ST stored in the image data memory GM. Specifically, the information indicating the page of the sheet ST read by the scanner 100 and the information indicating the front surface and the back surface of the sheet ST are attached as the identification information. Characters composed of “P” and a number indicating the arrangement order of the sheet ST are attached to the image data G as the identification information indicating the page of the sheet ST. Further, “A” is attached to the image data G as the identification information indicating the front surface of the sheet ST. Further, “B” is attached to the image data G as the identification information indicating the back surface of the sheet ST. Thus, “P1A” is attached to the image data G indicating the front surface of the sheet ST of the first page read by the scanner 100 as the identification information. “P15” is attached to the image data G indicating the back surface of the sheet ST of the first page as the identification information. “P2A” is attached to the image data G indicating the front surface of the sheet ST of the second page read by the scanner 100 as the identification information. “P2B” is attached to the image data G indicating the back surface of the sheet ST of the second page as the identification information. The arrangement order of the identification information attached to each image data G is shown in the determination result JR of the arrangement order determination section 420.

The arrangement order change section 430 rearranges the image data G stored in the image data memory GM of the storage section 300 on the basis of the determination result JR determined by the arrangement order determination section 420.

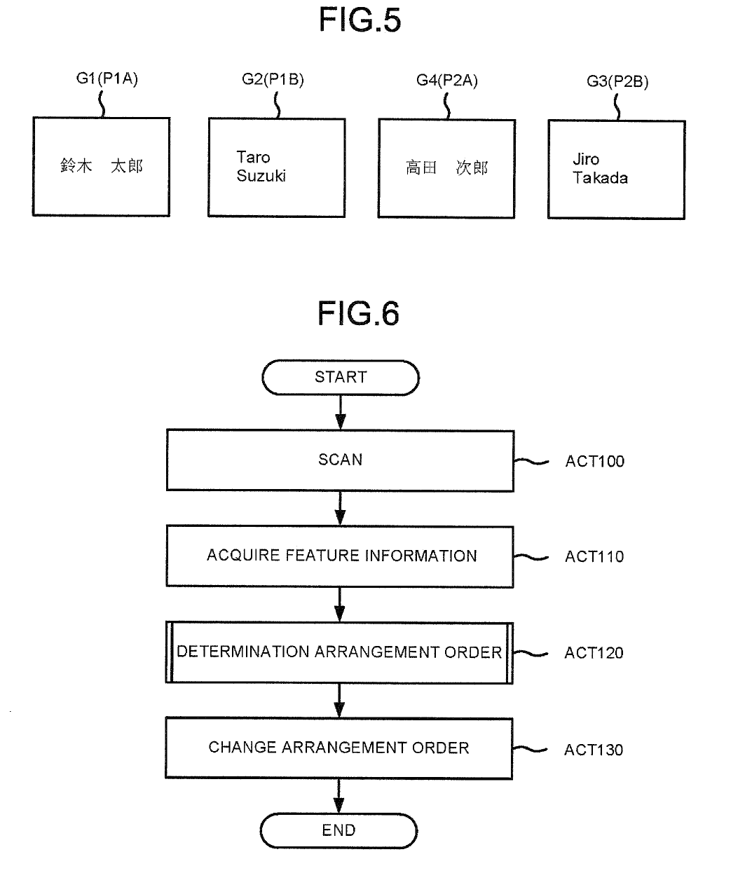

Hereinafter, details of determination of the arrangement order of the sheets ST by the arrangement order determination section 420 are described with reference to FIG. 4 and FIG. 5.

FIG. 4 is a diagram illustrating a first example of the sheet ST read by the scanner 100.

FIG. 5 is a diagram illustrating a first example of the image data G rearranged by the arrangement order change section 430.

In one example shown in FIG. 4, the scanner 100 reads two sheets ST, and generates the image data G including image data G1-image data G4. The sheet ST read by the scanner 100 refers to, for example, a business card. The image data G1 is the image data G of the front surface of the first sheet ST read by the scanner 100. Further, the image data G2 is the image data G of the back surface of the first sheet ST read by the scanner 100. Further, the image data G3 is the image data G of the front surface of the second sheet ST read by the scanner 100. Further, the image data G4 is the image data G of the back surface of the second sheet ST read by the scanner 100.

The identification information of the image data G1 is the “P1A”. The identification information of the image data G2 is the “P1B”. The identification information of the image data G3 is the “P2A”. The identification information of the image data G4 is the “P2B”.

As shown in FIG. 4, “ [symbol] ” in Japanese is described in the image data G1. Further, “Taro Suzuki” in English is described in the image data G2. Further, “Jiro Takada” in English is described in the image data G3. Further, “ [symbol] ” in Japanese is described in the image data G4.

In other words, the feature information acquisition section 410 supplies the feature information DF1 indicating that the image data G1-the image data G4 are not blank to the arrangement order determination section 420. The feature information acquisition section 410 supplies the feature information DF2 indicating that the image data G1 and the image data G4 are the descriptions of Japanese to the arrangement order determination section 420. The feature information acquisition section 410 supplies the feature information DF2 indicating that the image data G2 and the image data G3 are the descriptions of English to the arrangement order determination section 420. The feature information acquisition section 410 supplies the feature information DF3 indicating that no page number is attached to the image data G1-the image data G4 to the arrangement order determination section 420.

In this example, the user selects the arrangement (order information AR22) for arranging the pages of English are arranged after the pages of Japanese as the arrangement of the sheets ST, and inputs the selected arrangement to the operation section 200. The arrangement order determination section 420 determines the arrangement order of the image data G1-the image data G4 on the basis of the order information AR22 and the feature information DF (feature information DF1-feature information DF3). Specifically, the arrangement order determination section 420 determines the arrangement order to arrange the page of English after the page of Japanese on the basis of the feature information DF2 and the order information AR22. More specifically, the arrangement order determination section 420 determines that the order of the image data G3 and the image data G4 is reversed. The arrangement order change section 430 changes the order of the image data G stored in the image data memory GM on the basis of the determination result JR of the arrangement order determination section 420. Specifically, as shown in FIG. 5, the arrangement order change section 430 sets the image of the identification information “P1A” to the image data G1. Further, the arrangement order change section 430 sets the image of the identification information “P1B” to the image data G2. Further, the arrangement order change section 430 sets the image of the identification information “P2A” to the image data G4. Further, the arrangement order change section 430 sets the image of identification information “P2B” to the image data G3. The arrangement order change section 430 changes the order of the image data G and stores the changed order in the image data memory GM.

Hereinafter, details of operations of the image processing apparatus 1 are described with reference to FIG. 6.

FIG. 6 is a flowchart illustrating an example of the operations of the image processing apparatus 1 according to the first embodiment.

The scanner 100 reads the image on the sheet ST to generate the image data G (ACT 100). The arrangement order determination section 420 acquires the feature information DF on the basis of the image data G generated by the scanner 100 (ACT 110). The arrangement order change section 430 determines the arrangement order of the sheets ST on the basis of the order information AR received by the operation section 200 and the feature information DF acquired by the arrangement order determination section 420 (ACT 120). The arrangement order change section 430 changes the order of the image data G on the basis of the determination result JR of the arrangement order determination section 420 (ACT 130).

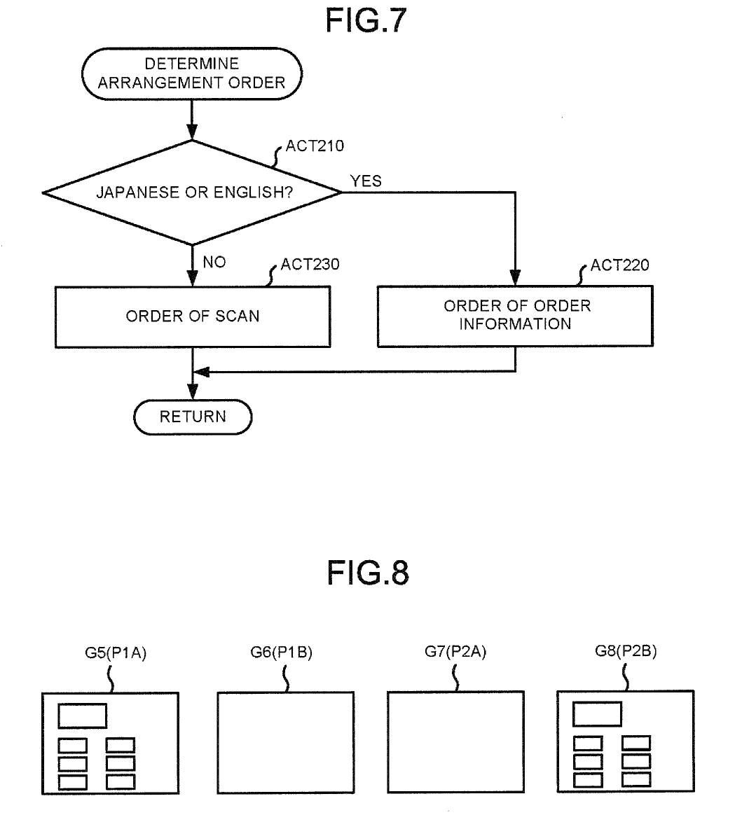

Hereinafter, details of the determination of the arrangement order determination section 420 are described with reference to FIG. 7.

FIG. 7 is a flowchart illustrating an example of the determination of the arrangement order determination section 420 according to the first embodiment. Specifically, FIG. 7 illustrates the details of the foregoing processing in ACT 120.

As stated above, in this example, the user selects the arrangement (order information AR22) for arranging the page of English after the page of Japanese as the arrangement of the sheets ST, and inputs the selected arrangement to the operation section 200.

The arrangement order determination section 420 determines whether Japanese or English is described on the sheet ST on the basis of the feature information DF and the order information AR22 (ACT 210). The arrangement order determination section 420 proceeds to a processing in ACT 220 if the feature information DF indicates that Japanese or English is described on the sheet ST (YES in ACT 210). The arrangement order determination section 420 determines that the image data G is rearranged in the order based on the foregoing order information AR22 (ACT 220). Further, the arrangement order determination section 420 proceeds to a processing in ACT 230 if the feature information DF indicates that neither Japanese nor English is described on the sheet ST (No in ACT 210). The arrangement order determination section 420 determines that the image data G is rearranged in the order of the read of the sheet ST by the scanner 100 (ACT 230).

As described above, the image processing apparatus 1 of the present embodiment is provided with the scanner 100, the operation section 200, the storage section 300 and the control section 400. The image data memory GM included in the storage section 300 stores the image data G of each sheet ST read by the scanner 100. The control section 400 includes the feature information acquisition section 410, the arrangement order determination section 420 and the arrangement order change section 430 as the functional sections thereof. The feature information acquisition section 410 acquires the feature information DF indicating the feature of each sheet ST on the basis of the image data G generated by the scanner 100. The arrangement order determination section 420 acquires the feature information DF acquired by the feature information acquisition section 410 and the order information AR received by the operation section 200. The arrangement order determination section 420 determines the arrangement order of the sheets ST on the basis of the feature information DF and the order information AR. The arrangement order change section 430 rearranges the image data G stored in the image data memory GM on the basis of the determination result JR determined by the arrangement order determination section 420.

Thus, according to the image processing apparatus 1 of the present embodiment, it is possible to rearrange the image data G on the basis of the feature of the sheet ST and a rearrangement method instructed by the user. For example, according to the image processing apparatus 1 of the present embodiment, even in a case in which a business card which is turned over and a business card which is not turned over are mixed to be scanned, it is possible to rearrange the image data G.

Further, the operation section 200 included in the image processing apparatus 1 of the present embodiment receives the input of the order information AR indicating the arrangement of the sheets ST. Further, the arrangement order determination section 420 determines the arrangement order of the sheets ST on the basis of the order information AR input to the operation section 200.

In this way, the image processing apparatus 1 of the present embodiment can acquire an arrangement of sheets ST desired by the user with a simple method.

The order information AR indicating the arrangement of the sheets ST may be stored in the storage section 300 but not input to the operation section 200. In this case, the storage section 300 includes an order information memory ARM. The arrangement order determination section 420 determines the arrangement order of the sheets ST on the basis of the order information AR read from the order information memory ARM and the feature information DF.

In this way, the image processing apparatus 1 of the present embodiment can reduce time taken by the user to select the order information AR.

In the foregoing description, a case in which the user selects the order information AR22 as the arrangement of the sheets ST and inputs the order information AR22 to the operation section 200 is described; however, the present invention is not limited to this.

Hereinafter, a case in which the user selects the order information AR11 as the arrangement of the sheets ST and inputs the order information AR11 to the operation section 200 is described.

FIG. 8 is a diagram illustrating a second example of the sheet ST read by the scanner 100.

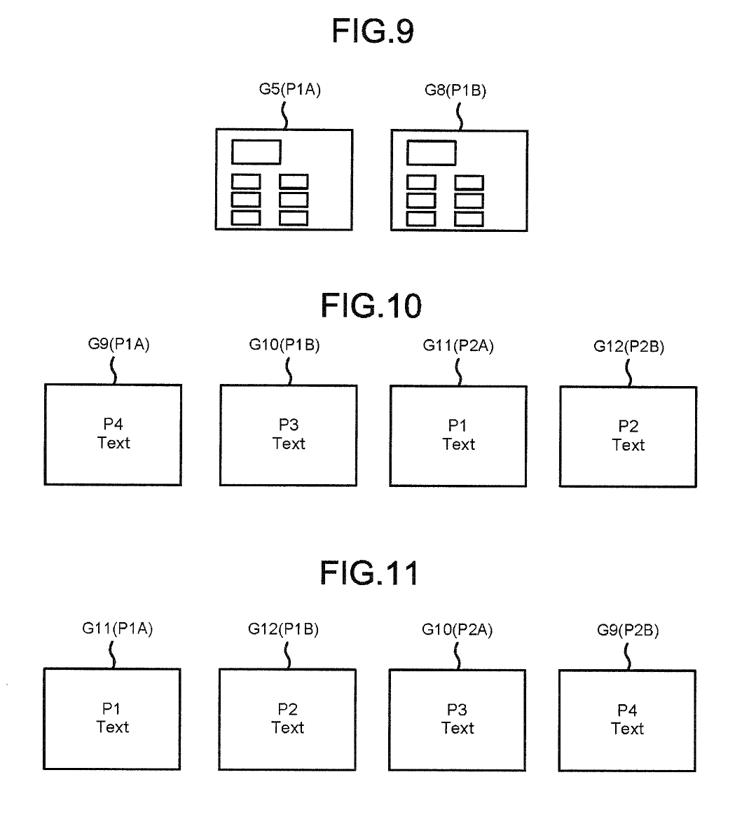

FIG. 9 is a diagram illustrating a second example of the image data G rearranged by the arrangement order change section 430.

In one example shown in FIG. 8, the scanner 100 reads two sheets ST, and generates the image data G of image data G5-image data G8. The sheet ST read by the scanner 100 refers to, for example, a business form. The business form refers to a document conforming to a fixed form such as an account book, a slip and the like. Specifically, numbers and languages are described on the business form. In this example, numbers and Japanese are described on the business form. The identification information of the image data G5 is “P1A”. Further, the identification information of the image data G6 is “P1B”. Further, the identification information of the image data G7 is “P2A”. Further, the identification information of the image data G8 is “P2B”.

As shown in FIG. 8, the business forms are described in the image data G5 and the image data G8. Further, the image data G6 and the image data G7 are blank.

In other words, the feature information acquisition section 410 supplies the feature information DF1 indicating that the image data G5 and the image data G8 are not blank to the arrangement order determination section 420. Further, the feature information acquisition section 410 supplies the feature information DF1 indicating that the image data G6 and the image data G7 are blank to the arrangement order determination section 420. The feature information acquisition section 410 supplies the feature information DF2 indicating that the image data G5 and the image data G8 are descriptions of Japanese to the arrangement order determination section 420. The feature information acquisition section 410 supplies the feature information DF2 indicating that there are no descriptions of Japanese or English in the image data G6 and the image data G7 to the arrangement order determination section 420. The feature information acquisition section 410 supplies the feature information DF3 indicating that the page numbers are not attached to the image data G5-the image data G8 to the arrangement order determination section 420.

As stated above, in this example, the user selects the order information AR11 as the arrangement of the sheets ST to input the order information AR11 to the operation section 200. The arrangement order determination section 420 determines the arrangement order of the image data G5-the image data G8 on the basis of the order information AR11 and the feature information DF (feature information DF1-feature information DF3). Specifically, the arrangement order determination section 420 determines that a blank page is deleted and the page after the deleted page is moved to the page just before the deleted page. More specifically, the arrangement order determination section 420 determines that the image data G6 and the image data G7 are deleted and the page of the image data G8 is moved to the page just before the deleted pages on the basis of the feature information DF1 and the order information AR11. The arrangement order change section 430 changes the order of the image data G stored in the image data memory GM on the basis of the determination result JR of the arrangement order determination section 420. Specifically, as shown in FIG. 9, the arrangement order change section 430 sets the image of the identification information “P1A” to the image data G5. Further, the arrangement order change section 430 sets the image of the identification information “P1B” to the image data G8. The arrangement order change section 430 changes the order of the image data G, and stores the changed order in the image data memory GM.

Thus, according to the image processing apparatus 1 of the present embodiment, it is possible to rearrange the image data G on the basis of the feature of the sheet ST and a rearrangement method instructed by the user. For example, according to the image processing apparatus 1 of the present embodiment, even in a case in which the business form of which the back surface is blank is scanned, it is possible to rearrange the image data G.

Furthermore, in the foregoing description, a case in which the order information AR22 or the order information AR11 is input to the operation section 200 as the arrangement of the sheets ST is described; however, the present invention is not limited to this.

Hereinafter, a case in which the user selects the order information AR31 as the arrangement of the sheets ST and inputs the order information AR31 to the operation section 200 is described.

FIG. 10 is a diagram illustrating a third example of the sheet ST read by the scanner 100.

FIG. 11 is a diagram illustrating a third example of the image data G rearranged by the arrangement order change section 430.

In one example shown in FIG. 10, the scanner 100 reads two sheets ST, and generates the image data G of image data G9-image data G12. The sheet ST read by the scanner 100 refers to, for example, a general document described in English. The identification information of the image data G9 is “P1A”. Further, the identification information of the image data G10 is “P1B”. Further, the identification information of the image data G11 is “P2A”. Further, the identification information of the image data G12 is “P2B”.

As shown in FIG. 10, English is described in the image data G9-the image data G12. Further, the page numbers are respectively attached to the image data G9-the image data G12. Specifically, “P4” as the page number and “Text” in English are described in the image data G9. Further, “P3” as the page number and “Text” in English are described in the image data G10. Further, “P1” as the page number and “Text” in English are described in the image data G11. Further, “P2” as the page number and “Text” in English are described in the image data G12.

In other words, the feature information acquisition section 410 supplies the feature information DF1 indicating that the image data G9-the image data G12 are not blank to the arrangement order determination section 420. The feature information acquisition section 410 supplies the feature information DF2 indicating that the image data G9-the image data G12 are descriptions of English to the arrangement order determination section 420. The feature information acquisition section 410 supplies the feature information DF3 indicating the page numbers attached to the image data G9-the image data G12 to the arrangement order determination section 420.

As stated above, in this example, the user selects the order information AR31 as the arrangement of the sheets ST, and inputs the order information AR31 to the operation section 200. The arrangement order determination section 420 determines the arrangement order of the image data G9-the image data G12 on the basis of the order information AR31 and the feature information DF (feature information DF1-feature information DF3). Specifically, the arrangement order determination section 420 rearranges the image data G in such a manner that the page numbers are arranged in ascending order on the basis of the page numbers attached to the respective sheets ST. More specifically, the arrangement order determination section 420 determines that the image data G is rearranged in the order of the image data G11, the image data G12, the image data G10 and the image data G9 on the basis of the feature information DF3 and the order information AR31. The arrangement order change section 430 changes the order of the image data G stored in the image data memory GM on the basis of the determination result JR of the arrangement order determination section 420. Specifically, as shown in FIG. 11, the arrangement order change section 430 sets the image of the identification information “P1A” to the image data G11. Further, the arrangement order change section 430 sets the image of the identification information “P1B” to the image data G12. Further, the arrangement order change section 430 sets the image of the identification information “P2A” to the image data G10. Further, the arrangement order change section 430 sets the image of the identification information “P2B” to the image data G9. The arrangement order change section 430 changes the order of the image data G, and stores the changed order in the image data memory GM.

Thus, according to the image processing apparatus 1 of the present embodiment, it is possible to rearrange the image data G on the basis of the feature of the sheet ST and a rearrangement method instructed by the user. For example, according to the image processing apparatus 1 of the present embodiment, even in a case in which the general documents that are not arranged according to the page numbers are scanned, it is possible to rearrange the image data G.

Furthermore, in the foregoing description, a case in which the arrangement order determination section 420 rearranges the image data G in such a manner that the page numbers attached to the respective sheets ST are arranged in ascending order is described; however, the present invention is not limited to this. The arrangement order determination section 420 may rearrange the image data G in such a manner that the page numbers are arranged in descending order on the basis of the page numbers attached to the respective sheets ST.

Hereinafter, a second embodiment of the present invention is described with reference to the figures.

In the first embodiment, a case in which the image processing apparatus 1 rearranges the sheets ST on the basis of one order information AR in the plurality of the order information AR corresponding to the feature information DF is described.

In the second embodiment, a case in which an image processing apparatus 2 rearranges sheets ST on the basis of a plurality of order information AR in the order information AR corresponding to the feature information DF is described.

The same elements as the first embodiment described above are applied with the same reference numerals, and the detailed descriptions thereof are omitted.

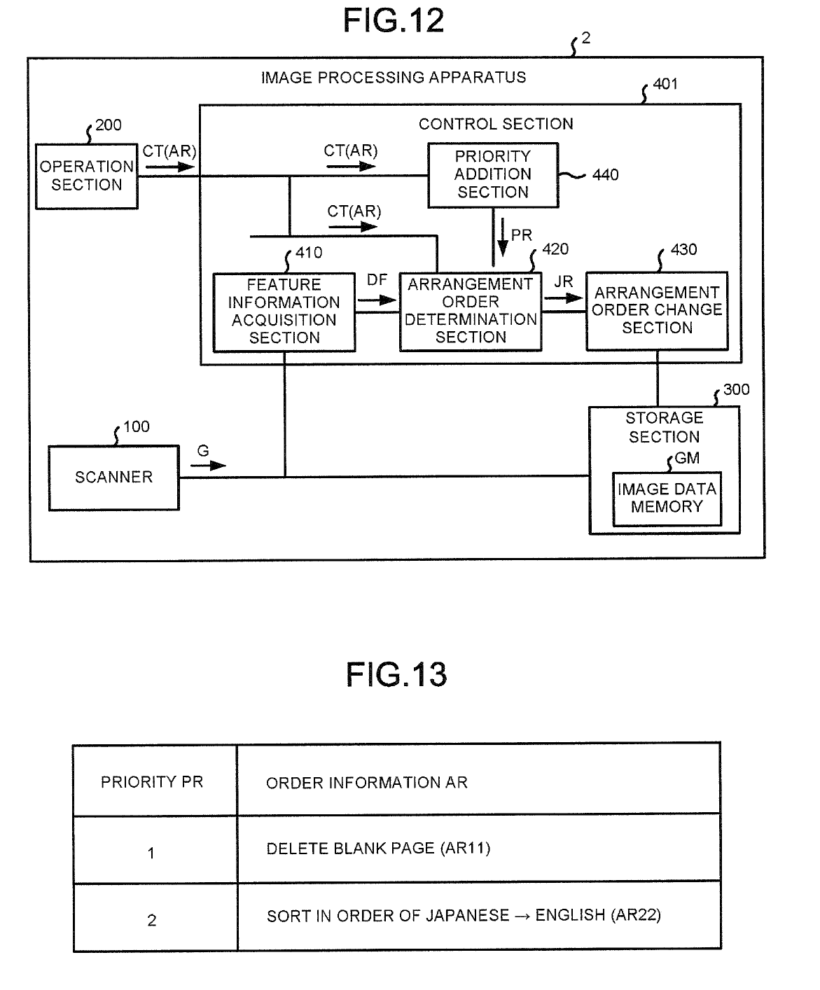

FIG. 12 is a functional block diagram illustrating an example of functional components of the image processing apparatus 2 according to the second embodiment.

The image processing apparatus 2 is provided with the scanner 100, the operation section 200, the storage section 300 and a control section 401.

As stated above, in the present embodiment, the operation section 200 receives the input of the plurality of the order information AR. The operation section 200 receives the instruction information CT for instructing the plurality of the acquired order information AR, and supplies the instruction information CT to the control section 401. The operation section 200 is an example of a second input section.

The control section 401 including a CPU is provided with the feature information acquisition section 410, the arrangement order determination section 420, the arrangement order change section 430 and a priority addition section 440 as functional sections thereof.

The priority addition section 440 acquires the instruction information CT from the operation section 200. The priority addition section 440 adds priorities PR to the plurality of the order information AR included in the instruction information CT. The image processing apparatus 2 carries out a processing of the rearrangement of the sheets ST on the basis of order information AR to which a high priority PR is added in the plurality of the order information AR. Further, the image processing apparatus 2 carries out a processing of the rearrangement of the sheets ST on the basis of order information AR to which a low priority PR is added after the previous processing. In this example, the priority addition section 440 adds the priority PR to the order information AR on the basis of a selection order for selecting the order information AR with the operation section 200 by the user. Specifically, the priority addition section 440 adds a higher priority PR to the previously selected order information AR on the basis of the instruction information CT. More specifically, the priority addition section 440 adds the highest priority PR to the order information AR selected firstly. Further, the priority addition section 440 adds the lowest priority PR to the order information AR selected last. The priority addition section 440 supplies the priority PR applied to the order information AR to the arrangement order determination section 420.

Furthermore, in the foregoing description, a case in which the priority addition section 440 selects the priority PR on the basis of the selection order of the order information AR is described; however, the present invention is not limited to this. For example, the operation section 200 may receive the priority PR for each order information AR selected by the user. In this case, the priority addition section 440 adds the priority PR corresponding to the order information AR on the basis of the order information AR and the priority PR acquired from the operation section 200.

Hereinafter, the correspondence between the order information AR and the priority PR is described with reference to FIG. 13. FIG. 13 is a table illustrating an example of the priority PR according to the second embodiment.

The priority PR indicates a small value in a case in which the priority PR is high, and indicates a large value in a case in which the priority PR is low. Furthermore, the priority PR may be indicated by another constitution instead of the constitution indicated by a numerical value as long as it is possible that the constitution indicates height and low of the priority PR.

As shown in FIG. 13, in this example, the user inputs the order information AR22 to the operation section 200 after selecting the order information AR11. Thus, the priority addition section 440 adds “1” as the priority PR to the order information AR11, and adds “2” as the priority PR to the order information AR22.

Returning to FIG. 12, the arrangement order determination section 420 acquires the instruction information CT including the plurality of the order information AR from the operation section 200. The arrangement order determination section 420 acquires the priority PR of each order information AR from the priority addition section 440. The arrangement order determination section 420 acquires the feature information DF from the feature information acquisition section 410. The arrangement order determination section 420 determines the arrangement order of the sheets ST on the basis of the priority PR, the plurality of the order information AR and the feature information DF. Specifically, the arrangement order determination section 420 determines the arrangement order of the sheets ST on the basis of the order information AR to which a high priority PR is added in the plurality of the order information AR. Next, the arrangement order determination section 420 determines the arrangement order of the sheets ST on the basis of the order information AR to which a high priority PR next to the high priority PR is added.

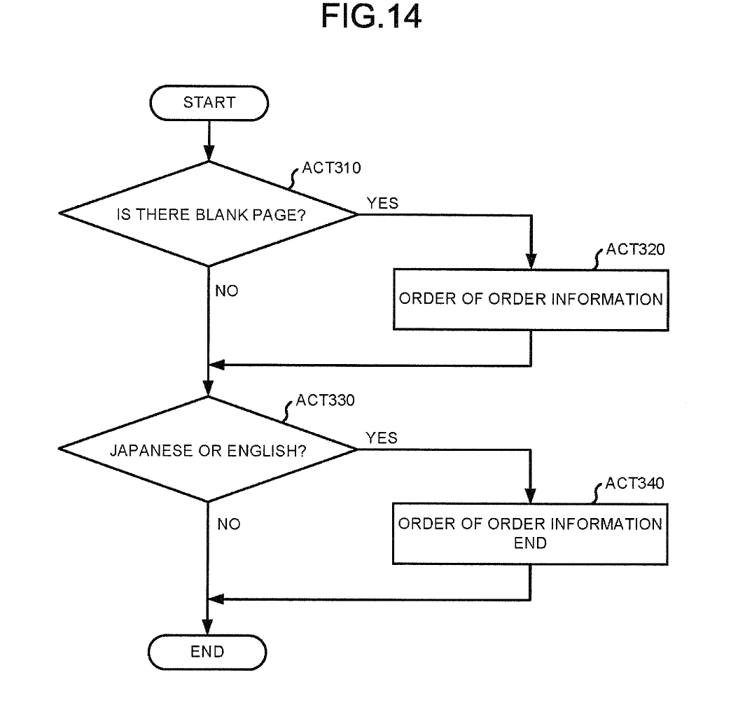

Hereinafter, the details of the determination of the arrangement order determination section 420 are described with reference to FIG. 14.

FIG. 14 is a flowchart illustrating an example of the determination of the arrangement order determination section 420 according to the second embodiment.

The arrangement order determination section 420 determines the arrangement order of the sheets ST on the basis of the order information AR to which a priority PR is added in the acquired order information AR. In this example, the arrangement order determination section 420 determines the arrangement order of the sheets ST on the basis of the order information AR11 of which the priority PR is “1”. More specifically, the arrangement order determination section 420 determines whether or not there is a blank page on the sheet ST on the basis of the feature information DF and the order information AR11 (ACT 310). The arrangement order determination section 420 proceeds to a processing in ACT 320 if it is determined that there is the blank page on the sheet ST (YES in ACT 310). The arrangement order determination section 420 proceeds to a processing in ACT 330 if it is determined that there is no blank page on the sheet ST (No in ACT 310). The arrangement order determination section 420 determines that the image data G is rearranged in the order based on the feature information DF1 and the order information AR11 described above (ACT 320).

Next, the arrangement order determination section 420 determines the arrangement order of the sheets ST on the basis of the order information AR to which the next higher priority PR is added in the acquired order information AR. In this example, the arrangement order determination section 420 determines the arrangement order of the sheets ST on the basis of the order information AR22 of which the priority PR is “2”. More specifically, the arrangement order determination section 420 determines whether Japanese or English is described on the sheet ST on the basis of the feature information DF and the order information AR22 (ACT 330). The arrangement order determination section 420 proceeds to a processing in ACT 340 if it is determined that Japanese or English is described on the sheet ST (YES in ACT 330). The arrangement order determination section 420 ends the processing if it is determined that neither Japanese nor English is described on the sheet ST (No in ACT 330). The arrangement order determination section 420 determines that the image data G is rearranged in the order based on the feature information DF2 and the order information AR22 described above (ACT 340).

As described above, the priority addition section 440 included in the image processing apparatus 2 of the present embodiment adds the priorities PR to the arrangements of the sheets ST indicated by the plurality of the order information AR. Further, the arrangement order determination section 420 determines the arrangement order of the sheets ST on the basis of the priority PR added by the priority addition section 440, the order information AR and the feature information DF.

Thus, according to the image processing apparatus 2 of the present embodiment, it is possible to rearrange the image data G on the basis of a plurality of the arrangements of the sheets ST.

Further, the operation section 200 included in the image processing apparatus 2 of the present embodiment receives the input of the order information AR and the priority PR of the order information AR. Further, the priority addition section 440 adds the priority PR to the order information AR on the basis of the order information AR input to the operation section 200.

In this way, the image processing apparatus 2 of the present embodiment can acquire an arrangement of sheets ST desired by the user with a simple method and the priority of the arrangement.

Furthermore, there may be a constitution in which the information indicating the priority PR of the order information AR is stored in the storage section 300 instead of the constitution in which the operation section 200 receives the input of the order information AR and the priority PR. In this case, the storage section 300 includes a priority information memory PRM. The priority addition section 440 adds the priority PR to the order information AR on the basis of the order information AR and the priority PR read from the priority information memory PRM.

In this way, the image processing apparatus 2 of the present embodiment can reduce time taken by the user to add the priority PR to the order information AR.

Hereinafter, a third embodiment of the present invention is described with reference to the figure.

In the first embodiment and the second embodiment, a case in which the order information AR desired by the user is input to the operation section 200 is described.

In the third embodiment, a case in which an image processing apparatus 3 determines order information AR suitable to an arrangement of sheets ST on the basis of the feature information DF of the sheets ST is described.

The same elements as the first embodiment and the second embodiment describe above are applied with the same reference numerals, and the detailed descriptions thereof are omitted.

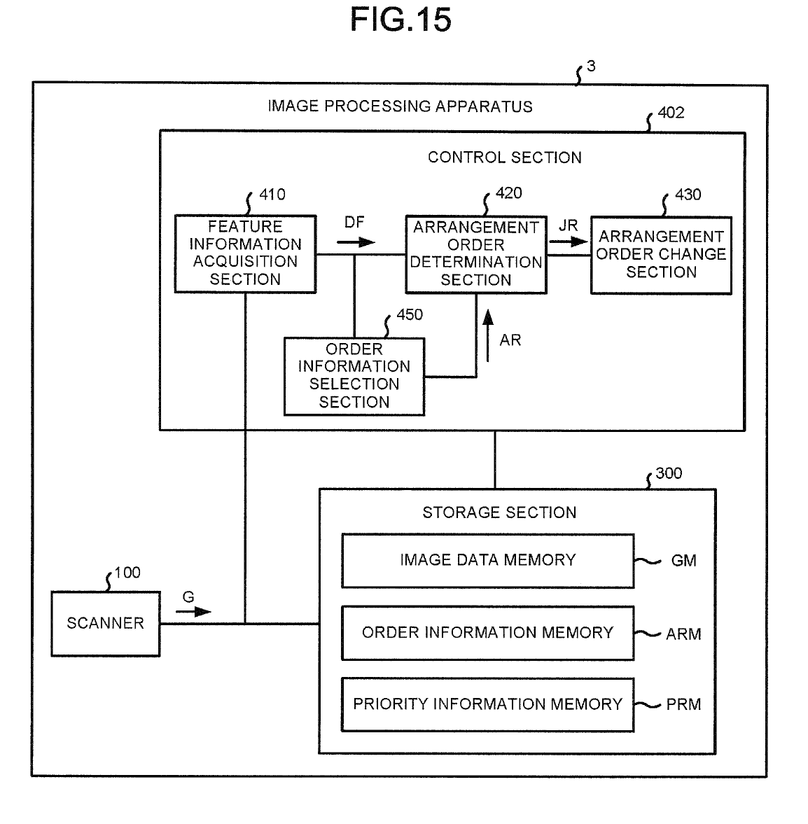

FIG. 15 is a functional block diagram illustrating an example of functional components of the image processing apparatus 3 according to the third embodiment.

The image processing apparatus 3 is provided with the scanner 100, the storage section 300 and a control section 402.

In the present embodiment, the image data memory GM, the order information memory ARM and the priority information memory PRM are stored in the storage section 300.

The order information AR corresponding to the feature information DF is stored in the order information memory ARM. In this example, the order information AR11 is stored in the order information memory ARM as the order information AR corresponding to the feature information DF1. Further, the order information AR21 is stored in the order information memory ARM as the order information AR corresponding to the second feature information DFP2. Further, the order information AR31 is stored in the order information memory ARM as the order information AR corresponding to the feature information DF3.

The control section 402 including a CPU is provided with the feature information acquisition section 410, the arrangement order determination section 420, the arrangement order change section 430 and an order information selection section 450 as functional sections thereof.

The order information selection section 450 selects the order information AR corresponding to the features of the sheet ST from the plurality of the order information AR on the basis of first feature information DFP1 and second feature information DFP2. The first feature information DFP1 refers to feature information DF indicating the feature of the sheet ST read firstly by the scanner 100. Specifically, the first feature information DFP1 refers to the feature information DF of the image data G to which the identification information “P1A” and “P1B” are attached. Further, the second feature information DFP2 refers to feature information DF indicating the feature of the sheet ST read secondly by the scanner 100. Specifically, the second feature information DFP2 refers to the feature information DF of the image data G to which the identification information “P2A” and “P2B” are attached. Specifically, the order information selection section 450 determines which one of the feature information DF the feature of the sheet ST is consistent with on the basis of the first feature information DFP1 and the second feature information DFP2. For example, there is a case in which one page with the feature information DF of the first feature information DFP1 and one page with the feature information DF of the second feature information DFP2 are blank. In this case, the order information selection section 450 determines that the feature information DF of the sheet ST is the feature information DF1. In this case, the order information selection section 450 selects the order information AR11 as the order information AR corresponding to the feature information DF1. Further, there is a case in which one page with the feature information DF of the first feature information DFP1 is the description of Japanese, the other page with the feature information DF of the first feature information DFP1 is the description of English, one page with the feature information DF of the second feature information DFP2 is the description of Japanese and the other page with the feature information DF of the second feature information DFP2 is the description of English. In this case, the order information selection section 450 determines that the feature information DF of the sheet ST is the feature information DF2. In this case, the order information selection section 450 selects the order information AR22 as the order information AR corresponding to the feature information DF2. In a case in which there is the description of the page number in the first feature information DFP1 and the second feature information DFP2, the order information selection section 450 determines that the feature information DF is the feature information DF3. In this case, the order information selection section 450 selects the order information AR31 as the order information AR corresponding to the feature information DF3. The order information selection section 450 supplies the selected order information AR to the arrangement order determination section 420.

The arrangement order determination section 420 determines the arrangement order of the sheets ST on the basis of the order information AR selected by the order information selection section 450 and the feature information DF.

As described above, the image processing apparatus 3 of the present embodiment is provided with the order information selection section 450. The order information selection section 450 selects the order information AR on the basis of the first feature information DFP1 and the second feature information DFP2 in the feature information DF. The arrangement order determination section 420 determines the arrangement order of the sheets ST on the basis of the order information AR selected by the order information selection section 450 and the feature information DF.

Thus, according to the image processing apparatus 3 of the present embodiment, it is possible to reduce time taken by the user to select the order information AR according to the feature of the sheet ST.

Hereinafter, a modification according to the third embodiment is described with reference to the figure.

In the third embodiment, a case in which the order information selection section 450 selects some order information AR on the basis of the first feature information DFP1 and the second feature information DFP2 is described. In the modification, a case in which the order information selection section 450 selects a plurality of order information AR on the basis of the first feature information DFP1 and the second feature information DFP2 is described.

As stated above, the order information selection section 450 determines which one of the feature information DF the feature of the sheet ST is consistent with on the basis of the first feature information DFP1 and the second feature information DFP2. There is a case in which the order information selection section 450 determines that the feature of the sheet ST is consistent with all of the feature information DF1-the feature information DF3. In this case, the order information selection section 450 selects the order information AR11, the order information AR21 and the order information AR31, and supplies the selected information to the arrangement order determination section 420.

Furthermore, in the foregoing description, a case in which the order information selection section 450 determines that the feature of the sheet ST is consistent with all of the feature information DF1-the feature information DF3 is described; however, the present invention is not limited to this. For example, there is a case in which the feature of the sheet ST is consistent with several excluding part of the feature information DF1-the feature information DF3. In this case, the order information selection section 450 may select the order information AR corresponding to the plurality of the feature information DF.

The arrangement order determination section 420 acquires the order information AR selected by the order information selection section 450. As stated above, in this example, the arrangement order determination section 420 acquires the order information AR11, the order information AR21 and the order information AR31. The arrangement order determination section 420 determines the arrangement order of the sheets ST on the basis of the acquired order information AR and the priority PR stored in the priority information memory PRM.

In this example, the priority PR added to each order information AR stored in the order information memory ARM is stored in the priority information memory PRM. The priority PR of the order information AR relating to the feature information DF1 is higher than those of the order information AR relating to other feature information DF. Further, the priority PR of the order information AR relating to the feature information DF3 is higher than that of the order information AR relating to the feature information DF2.

Thus, “1” as the priority PR of the order information AR11 is stored in the priority information memory PRM. Further, “2” as the priority PR of the order information AR31 is stored in the priority information memory PRM. Further, “3” as the priority PR of the order information AR22 is stored in the priority information memory PRM.

Thus, the arrangement order determination section 420 determines the arrangement order of the sheets ST on the basis of the order information AR11. Next, the arrangement order determination section 420 determines the arrangement order of the sheets ST on the basis of the order information AR31. Finally, the arrangement order determination section 420 determines the arrangement order of the sheets ST on the basis of the order information AR22.

The value of the priority PR attached to each order information AR is an example; however, the present invention is not limited to this. The values of the priorities PR of the order information AR corresponding to the feature information DF1, the feature information DF2 and the feature information DF3 may not be limited. Further, the values of the priorities PR attached to the plurality of the order information AR may be consistent.

Hereinafter, the details of the determination of the arrangement order determination section 420 are described with reference to the figure.

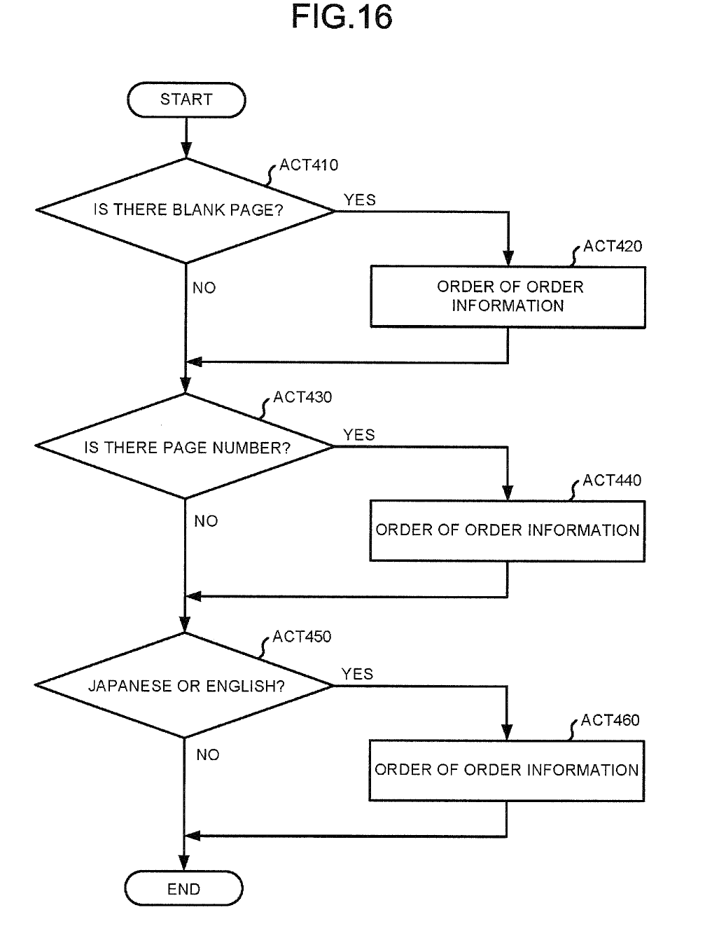

FIG. 16 is a flowchart illustrating an example of the determination of the arrangement order determination section 420 according to the modification.

The arrangement order determination section 420 determines the arrangement order of the sheets ST on the basis of the order information AR to which a high priority PR is added. In this example, the arrangement order determination section 420 determines the arrangement order of the sheets ST on the basis of the order information AR11 of which the priority PR is “1”. More specifically, the arrangement order determination section 420 determines whether or not there is a blank page on the sheet ST on the basis of the feature information DF and the order information AR11 (ACT 410). The arrangement order determination section 420 proceeds to a processing in ACT 420 if it is determined that there is the blank page on the sheet ST (YES in ACT 410). Further, the arrangement order determination section 420 proceeds to a processing in ACT 430 if it is determined that there is no blank page on the sheet ST (No in ACT 410). The arrangement order determination section 420 determines that the image data G is rearranged in the order based on the feature information DF1 and the order information AR11 described above (ACT 420).

Next, the arrangement order determination section 420 determines the arrangement order of the sheets ST on the basis of the order information AR to which the next higher priority PR is added in the acquired order information AR. In this example, the arrangement order determination section 420 determines the arrangement order of the sheets ST on the basis of the order information AR31 of which the priority PR is “2”. More specifically, the arrangement order determination section 420 determines whether or not the page number is described on the sheet ST on the basis of the feature information DF and the order information AR31 (ACT 430). The arrangement order determination section 420 proceeds to a processing in ACT 440 if it is determined that the page number is described on the sheet ST (YES in ACT 430). Further, the arrangement order determination section 420 proceeds to a processing in ACT 450 if it is determined that the page number is not described on the sheet ST (No in ACT 430). The arrangement order determination section 420 determines that the image data G is rearranged in the order based on the feature information DF3 and the order information AR31 described above (ACT 440).

Next, the arrangement order determination section 420 determines the arrangement order of the sheets ST on the basis of the order information AR to which the next higher priority PR is added in the acquired order information AR. In this example, the arrangement order determination section 420 determines the arrangement order of the sheets ST on the basis of the order information AR22 of which the priority PR is “3”. More specifically, the arrangement order determination section 420 determines whether or not Japanese or English is described on the sheet ST on the basis of the feature information DF and the order information AR22 (ACT 450). The arrangement order determination section 420 proceeds to a processing in ACT 460 if it is determined that Japanese or English is described on the sheet ST (YES in ACT 450). Further, the arrangement order determination section 420 ends the processing if it is determined that neither Japanese nor English is described on the sheet ST (No in ACT 450). The arrangement order determination section 420 determines that the image data G is rearranged in the order based on the feature information DF2 and the order information AR22 described above (ACT 460).

As described above, according to the image processing apparatus 3 of the modification, it is possible to reduce time taken by the user to select the order information AR according to the feature of the sheet ST. Further, according to the image processing apparatus 3 of the modification, it is possible to rearrange the image data G on the basis of the plurality of the arrangements of the sheets ST.

Furthermore, in the foregoing description, a case in which the feature of the sheet ST is indicated by the feature information DF1-the feature information DF3 is described; however, the present invention is not limited to this. The feature of the sheet ST may be indicated by feature information DF other than the feature information DF1-the feature information DF3. For example, the feature of a sheet ST may be a size of the sheet ST. Further, the feature of a sheet ST may be a position of a hole punched on the sheet ST for the purpose of binding the sheet ST. Further, the feature information DF1 may be information based on an OCR (Optical Character Recognition) result of the sheet ST. For example, if a decipherable OCR result as an article is described in the image data G, the feature information DF1 indicates that the sheet ST is not the blank paper. Further, if the OCR result is described in the image data G, the feature information DF1 is the information indicating that the sheet ST is the blank paper. Further, the feature of the sheet ST may be information indicating the front surface and the back surface of the sheet ST. In this case, if a decipherable OCR result as an article is described in the image data G, the feature information DF indicates the front surface of the sheet ST. Further, if the OCR result is not described in the image data G or an undecipherable OCR result as an article is described therein, the feature information DF indicates the back surface of the sheet ST.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

1. An image processing apparatus, comprising:
a scanner configured to read a plurality of sheets;
an image data memory configured to store image data of each sheet read by the scanner;
a processor configured to execute instructions;
a feature information acquisition section configured to acquire feature information indicating a feature of each of the sheets on the basis of the image data;
an order information memory configured to store a plurality of order information corresponding to a plurality of feature information;
an order information selection section configured to select the order information on the basis of first feature information indicating a feature of the image data of a first sheet read by the scanner and second feature information indicating a feature of the image data of a second sheet read by the scanner, the image data of the first sheet contains the image data of the front surface and the back surface of the first sheet, the image data of the second sheet contains the image data of the front surface and the back surface of the second sheet;
an arrangement order determination section configured to determine an arrangement order of the sheets on the basis of the order information selected by the order information selection section and the feature information; and
an arrangement order change section configured to rearrange the image data stored in the image data memory on the basis of the arrangement order determined by the arrangement order determination section.

2. (canceled)

3. (canceled)

4. (canceled)

5. The image processing apparatus according to claim 1, wherein a plurality of information indicating the arrangement of the sheets is included in the order information, further comprising:
a priority addition section configured to add priorities to the plurality of the arrangements included in the order information, wherein the arrangement order determination section determines the arrangement order of the sheets on the basis of the priority added by the priority addition section, the order information, and the feature information.

6. The image processing apparatus according to claim 5, further comprising:
an operation section configured to receive an input of the priority, wherein
the priority addition section adds the priorities input to the operation section to the plurality of the arrangements included in the order information.

7. The image processing apparatus according to claim 5, further comprising:
a priority information memory configured to store the priority, wherein
the priority addition section adds the priorities stored in the priority information memory to the plurality of the arrangements included in the order information.

8. The image processing apparatus according to claim 5, wherein
the arrangement order determination section determines the arrangement order of the sheets on the basis of the order information of which the priority is high and the feature information.

9. The image processing apparatus according to claim 1, wherein
the arrangement order change section rearranges the image data in the order of the read of the image data stored in the image data memory in a case in which the arrangement order determination section cannot determine an arrangement order.

10. The image processing apparatus according to claim 1, wherein the feature information comprises at least one of a page number, a page header, a page footer, and an identity of language typed on the sheets.

11. An image processing method by a computer which comprises a scanner configured to read a plurality of sheets and an image data memory configured to store image data of each sheet read by the scanner, including:
acquiring feature information indicating a feature of each of the sheets on the basis of the image data;
storing a plurality of order information corresponding to a plurality of feature information;
selecting the order information on the basis of first feature information indicating a feature of the image data of a first sheet read by the scanner and second feature information indicating a feature of the image data of a second sheet read by the scanner, the image data of the first sheet contains the image data of the front surface and the back surface of the first sheet, the image data of the second sheet contains the image data of the front surface and the back surface of the second sheet;
determining an arrangement order of the sheets on the basis of the order information and the feature information; and
rearranging the image data stored in the image data memory on the basis of the arrangement order determined by the arrangement order determination section.

12. (canceled)

13. (canceled)

14. (canceled)

15. The image processing method according to claim 11, wherein a plurality of information indicating the arrangement of the sheets is included in the order information, the method further comprising:
adding priorities to the plurality of the arrangements included in the order information; and
determining the arrangement order of the sheets on the basis of the priority added, the order information, and the feature information.

16. The image processing method according to claim 15, further comprising:
receiving an input of the priority; and
adding the priorities input to the plurality of the arrangements included in the order information.

17. The image processing method according to claim 15, further comprising:
storing the priority in a priority information memory; and
adding the priorities stored in the priority information memory to the plurality of the arrangements included in the order information.

18. The image processing method according to claim 15, wherein
determining the arrangement order comprises determining the arrangement order of the sheets on the basis of the order information of which the priority is high and the feature information.

19. The image processing method according to claim 11, further comprising:
rearranging the image data in the order of the read of the image data stored in the image data memory in a case in which an arrangement order cannot be determined.

20. The image processing method according to claim 11, wherein the feature information comprises at least one of a page number, a page header, a page footer, and an identity of language typed on the sheets.
